(19) United States
(12) Patent Application Publication
(10) Pub. No.: US 2025/0353043 A1
(43) Pub. Date: Nov. 20, 2025

(54) MULTI-CAPACITY PRESSURIZED FLUID WASHER APPARATUS

(71) Applicant: MTD PRODUCTS INC, Valley City, OH (US)

(72) Inventors: Jay Maggard, Polk, OH (US); Nicole Malernee, Valley City, OH (US); Axel Schaedler, Olmsted Falls, OH (US); Adam Woodrum, Wakeman, OH (US)

(21) Appl. No.: 19/207,616

(22) Filed: May 14, 2025

Related U.S. Application Data
(60) Provisional application No. 63/647,382, filed on May 14, 2024.

(51) Int. Cl. B08B 3/02

(52) U.S. Cl. CPC B08B 3/026; B08B 2203/0223; B08B 2203/027; B08B 2203/0282

(57) ABSTRACT

A pressure washer apparatus can have multiple output capacities defined by distinct water flow or pressurization paths. An operator can switch between flow or pressurization paths to vary pressurized water output, or combine multiple flow or pressurization paths to further vary pressurized water output. Different pressurized water outputs can have different fluid pressures, differing fluid flow rates, or the like, or a suitable combination of the foregoing. Some pressure washer apparatuses can achieve multiple output capacities while preserving a high power efficiency. Such an apparatus can be suitable for an electric powered device having relatively low power consumption yet favorable washing performance.

### CROSS-REFERENCE TO RELATED APPLICATIONS

The present application for patent claims the benefit of priority of U.S. Provisional Patent Application No. 63/647,382, filed May 14, 2024 and titled MULTI-CAPACITY PRESSURIZED POWER WASHER APPARATUS, and which is hereby incorporated by reference within the present disclosure in its entirety and for all purposes.

### FIELD OF DISCLOSURE

This application relates generally to a pressurized fluid output apparatus, and more specifically to a multiple capacity pressure washing apparatus that can be activated for efficiency or performance by operator selection.

### BACKGROUND

Pressure washing machines receive water from a water outlet and pressurize the water to enhance the cleaning capacity of the pressure washing machine. From a general perspective, pressurized water directs more energy to a target surface or object to loosen debris, material, adhesive or the like from the target surface. This helps to clean the target surface of material that might be difficult to remove with water output directly from the water outlet, or with manual washing and scrubbing, and so on.

Existing pressure washing machines utilize a pressure-generating pump to increase the pressure of water directed to a pressurized output. Different advantages have been provided among different machines, including relatively low weight and good mobility for residential use, high fuel capacity and power for commercial or industrial use, and others. Efforts to continue engineering new benefits for different types of machines utilized for different applications are ongoing.

### SUMMARY

The following presents a simplified summary in order to provide a basic understanding of some example aspects of the disclosure. This summary is not an extensive overview. Moreover, this summary is not intended to identify critical elements of the disclosure nor delineate the scope of the disclosure. The sole purpose of the summary is to present some concepts in simplified form as a prelude to the more detailed description that is presented later.

Aspects of the disclosed embodiments provide a pressure washer apparatus having multiple output capacities defined by distinct water flow or pressurization paths. An operator can switch between flow or pressurization paths to vary a pressurized water output, or combine multiple flow or pressurization paths to further vary pressurized water output. Different pressurized water outputs can have different fluid pressures, differing fluid flow rates, or the like, or a suitable combination of the foregoing. In some aspects, a disclosed pressure washer apparatus can achieve multiple output capacities while preserving a high power efficiency. Such an apparatus can be suitable for an electric powered device having relatively low power consumption yet favorable washing performance, in various embodiments of the present disclosure.

In an aspect(s) of the disclosed embodiments, provided is a pressure washer apparatus. The pressure washer apparatus can comprise a frame, an electric motor secured to the frame for generating mechanical power and a water inlet for receiving water. Additionally, the pressure washer apparatus can comprise a pump secured to the frame that receives water from the water inlet and mechanical power from the electric motor and generates pressurized water having a first increased pressure and a first fluid flow rate and can comprise a sprayer device for directing output water having the first increased pressure and the first fluid flow rate. Furthermore, the pressure washer apparatus can comprise an operator trigger for selectively releasing the output water at the sprayer device. Still further, the pressure washer apparatus can comprise an auxiliary output modality which, in response to activation of an operator input, increases the first increased pressure of the output water to a second increased pressure or increases the first fluid flow rate of the output water to a second fluid flow rate.

In one or more additional aspects of the disclosed embodiments, disclosed is a pressure washer apparatus. The pressure washer apparatus can comprise an alternating current (AC) power input, an AC to direct current (DC) converter that converts AC power received at the AC power input to DC power and a DC electric motor that receives the DC power and outputs mechanical power. Moreover, the pressure washer apparatus can comprise a water inlet that receives water at an input pressure and a pump that receives water from the water inlet and receives the mechanical power from the DC electric motor, and increases pressure of the water from the input pressure to a first increased pressure. In addition, the pressure washer apparatus can comprise a pressurized water output for selective release of output water at the first increased pressure and a first fluid flow rate and an operator trigger for activating and deactivating the release of the output water at the pressurized water output. Further, the pressure washer apparatus can comprise an auxiliary water output selectively activatable to generate second pressurized water and increase the first fluid flow rate of the output water at the pressurized water output to a second fluid flow rate, larger than the first fluid flow rate.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

The foregoing and other aspects of the present disclosure will become apparent to those skilled in the art to which the present disclosure relates upon reading the following description with reference to the accompanying drawings, in which:

FIG. 1 illustrates a diagram of an example pressure washer apparatus, according to various aspects discussed herein;

FIG. 2 depicts a schematic diagram of an example pressure washer apparatus with a selective secondary output capacity, in aspects of the disclosed embodiments;

FIG. 2A illustrates a schematic diagram of an alternative example pressure washer apparatus with selective secondary output capacity, in further aspects of the disclosure;

FIG. 3 illustrates a schematic diagram of an example pressure washer apparatus with secondary output and battery support, in further aspects of the disclosure;

FIG. 4 depicts a schematic diagram of a sample pressure washer apparatus with selective secondary water flow, in aspects of still additional embodiments of the disclosure;

FIG. 5 illustrates a schematic diagram of an example pressure washer apparatus with selective secondary output capacity facilitated by an accumulation tank;

FIG. 6 depicts a schematic diagram of an example pressure washer apparatus with selective secondary output capacity including a battery-boosted motor, in further aspects;

FIG. 7 depicts a schematic diagram of a sample pressure washer apparatus with battery-boosted motor and battery support, in still further aspects of the disclosed embodiments.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to providing user feedback and enhanced drivability in drive-by-wire systems for power equipment machines are described herein, it should be understood that the disclosed machines, electronic and computing devices and methods are not so limited and modifications may be made without departing from the scope of the present disclosure. The scope of the systems, methods, and electronic and computing devices for providing user feedback and enhanced drivability in drive-by-wire systems are defined by the appended claims, and all devices, processes, and methods that come within the meaning of the claims, either literally or by equivalence, are intended to be embraced therein.

### DETAILED DESCRIPTION

Example embodiments that incorporate one or more aspects of the present disclosure are described and illustrated in the drawings. These illustrated examples are not intended to be a limitation on the present disclosure. For example, one or more aspects of the present disclosure can be utilized in other embodiments and even other types of devices. Moreover, certain terminology is used herein for convenience only and is not to be taken as a limitation on the present disclosure. Still further, in the drawings, the same reference numerals are employed for designating the same elements, unless indicated otherwise or clear from context that elements having the same reference numerals in different figures incorporate different characteristics or different functionality.

As utilized herein, relative terms and terms of degree including the term “about”, “approximately”, “substantially”, “roughly”, “near” and others are intended to incorporate ranges and variations about a qualified term reasonably encountered by one of ordinary skill in the art in fabricating, compiling or optimizing the embodiments disclosed herein to suit design preferences, where not explicitly specified otherwise. When utilized to modify a numerical description of a disclosed element, a relative term can imply a suitable range about the given number. Any implied range is intended to be consistent with and achieve the same or similar functions as described for the disclosed structure given the numerical description, where applicable. Where such ranges are not explicitly disclosed, a range within typical manufacturing tolerances associated with suitable manufacturing equipment (e.g., injection molding equipment, extrusion equipment, metal stamping equipment, and so forth) understood by one of ordinary skill in the art for realizing an element from a disclosed illustration or description can be implied. In some embodiments, depending on context and the capabilities of one of ordinary skill in the art, relative terminology can refer to a variation in a disclosed value or characteristic; e.g., a zero to five-percent variance or a zero to ten-percent variance from precise mathematically defined value or characteristic, or any suitable value or range there between can define a scope for a disclosed term of degree. As an example, a disclosed mechanical dimension can have a variance of suitable manufacturing tolerances as would be understood by one of ordinary skill in the art, or a variance of a few percent about the disclosed mechanical dimension that would achieve a stated purpose or function of the disclosed mechanical dimension. Relative terms utilized for qualitative (rather than quantitative) description can be understood to imply explicitly stated alternatives or variations, variations understood in the art to occur from manufacturing tolerances or variations in a manufacturing process, variations understood in the art to achieve the function or purpose described for a particular component or process, or a suitable combination of the foregoing.

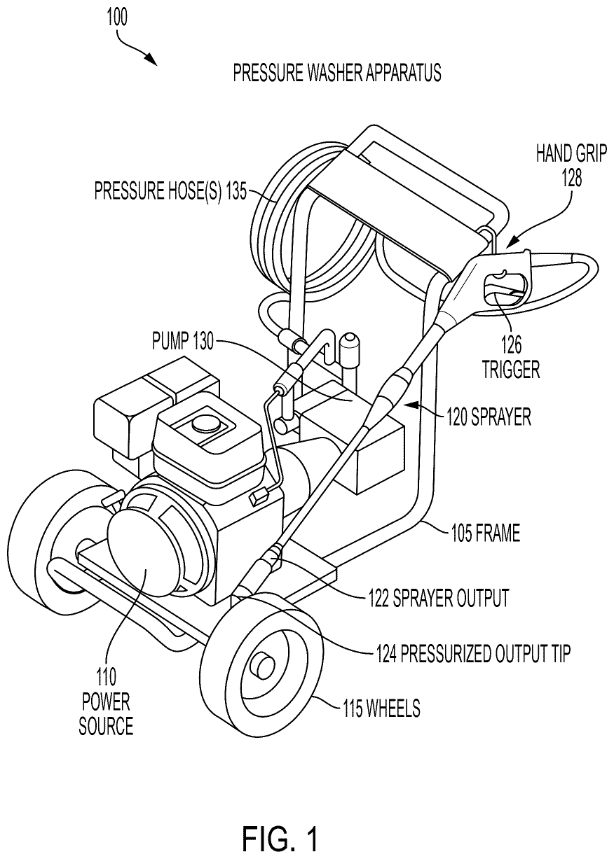

Referring to FIG. 1, an aspect of various embodiments of the present disclosure is illustrated as an example pressure washer apparatus 100. Pressure washer apparatus 100 can include a power source 110 for generating mechanical power that is output to a pump 130. Power source 110 and pump 130 can be secured to a frame 105 that is movable on one or more wheels 115.

Power source 110 can be a variety of suitable power sources that receive fuel, input power or the like, and generate mechanical power as an output of power source 110. Examples of suitable power sources that receive fuel can include a combustion engine for combusting a suitable fuel: including gasoline, diesel, propane, natural gas, liquid natural gas, hydrogen gas, hydrogen fuel cell, and so forth. Other suitable examples of a power source 110 can include an electric motor, a hydraulic motor, a pneumatic motor, and so forth. Similar devices or suitable combinations of any of the foregoing are considered within the scope of the present disclosure as well. Where suitable, mechanical power output by power source 110 can include pressurized gas (a pneumatic mechanical power), pressurized fluid (a hydraulic mechanical power), among others known in the art or reasonably conveyed to one of skill in the art by way of the context provided herein.

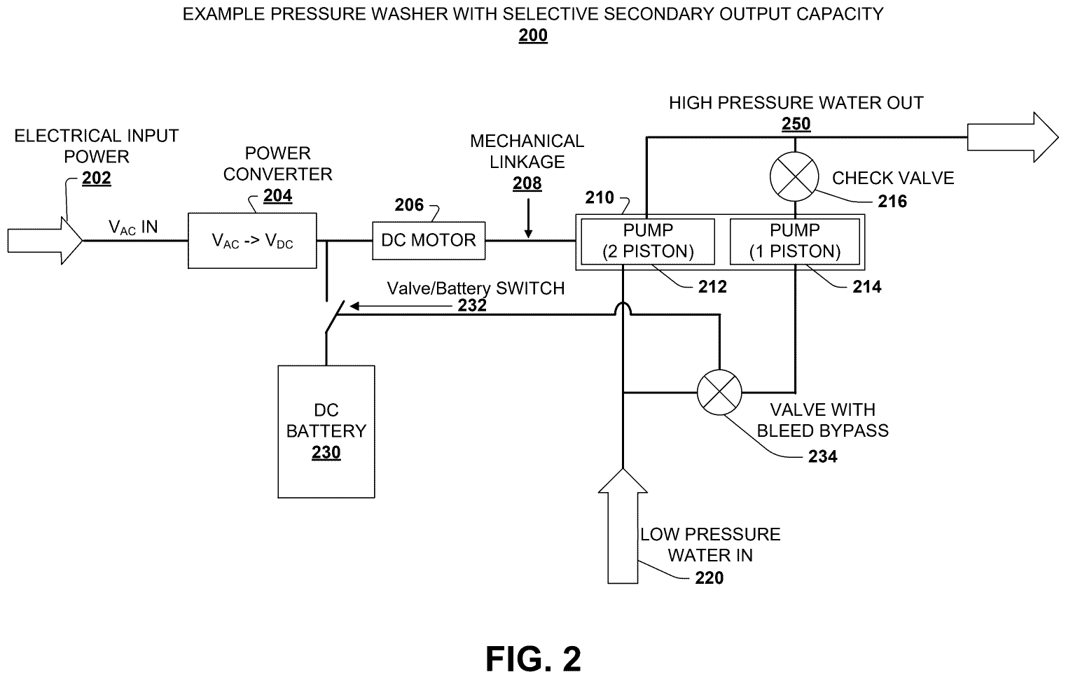

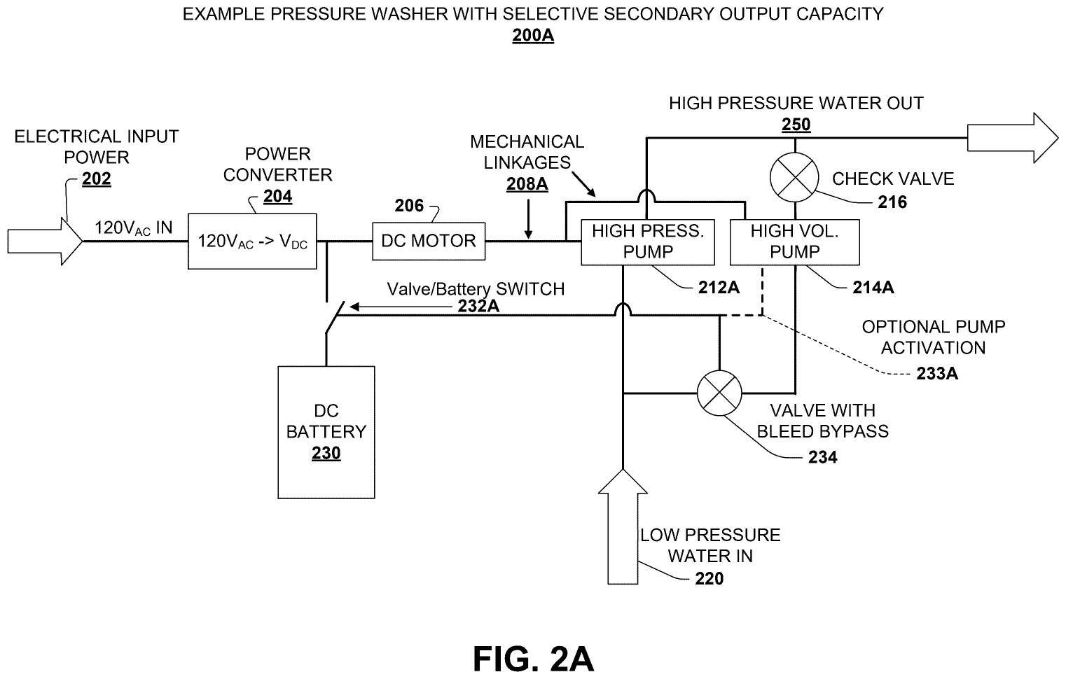

Pump 130 receives mechanical power from power source 110 and also receives water or other liquid from a liquid inlet at pressure washer apparatus 100 (not depicted, but see FIGS. 2-7, infra). Pump 130 produces a pressurized liquid as an output of pump 130, which is provided to one or more pressure hoses 135 at a fluid flow rate generated by pump 130. Note that the liquid and liquid inlet will hereinafter be referred to as water and a water inlet for simplicity, though other liquids including mixtures of water and a solute material(s), water mixed with one or more other non-water liquids or the like are within the scope of the present disclosure and could be substituted for water and a water inlet where suitable to one of skill in the art.

Pressure hose(s) 135 provides pressurized water at the fluid flow rate as an input to sprayer 120. Sprayer 120 can have a pressurized output tip 124 that increases pressure of water expelled from pressurized output tip 124 by constricting a surface area through which the pressurized water can flow. This reduces an output flow rate of water expelled at pressurized output tip 124, but achieves a pressure for the expelled water that is higher than that of the pressurized water produced by pump 130. In some aspects of the disclosed embodiments, pressurized output tip 124 can be one of a set of pressurized output tips that can be interchanged by an operator. Each output tip can have an associated maximum pressure and maximum fluid flow rate for a given water pressure and fluid flow rate produced by pump 130. Output tips can also have different divergence angles for the expelled water, from a narrow stream to a wide angle spray and various divergence angles there between, as is understood in the art.

Sprayer 120 includes an operator hand grip 128 and a trigger 126. Activation of trigger 126 permits water received at sprayer 120 from pressure hose(s) 135 to proceed to sprayer output 122 and pressurized output tip 124 to be expelled from sprayer 120 as described above.

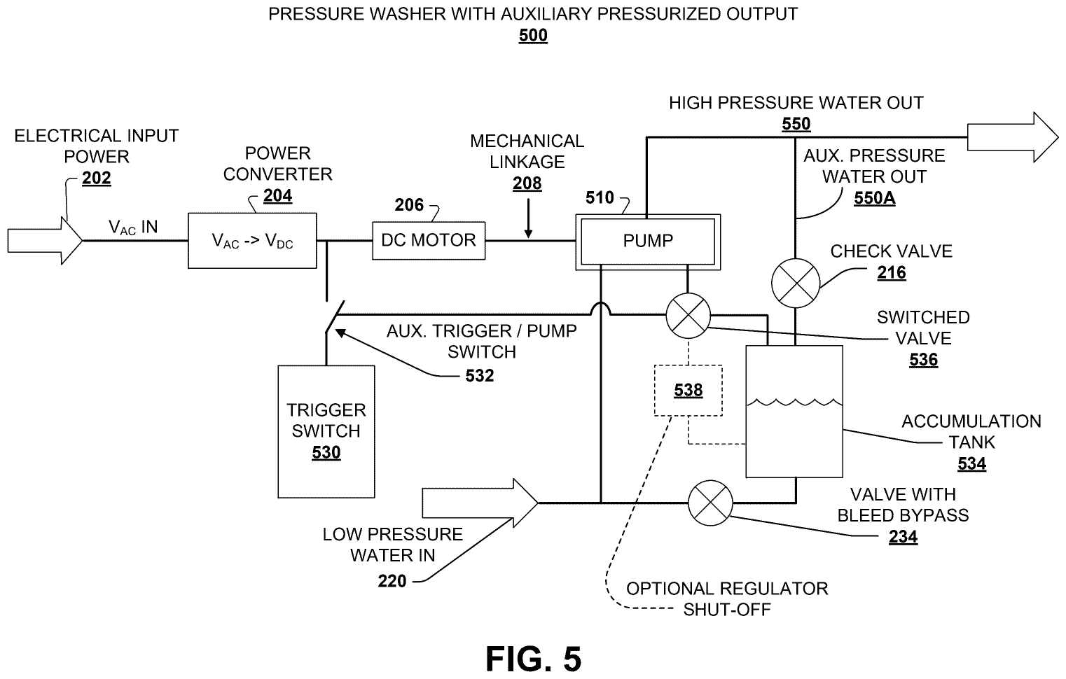

In various aspects of the embodiments disclosed herein, pressure washer apparatus 100 can have one or more additional output capacities to that described above. The additional output capacity(ies) can facilitate an independent flow of liquid (e.g., water) at a pressure and flow rate different from or independent of (or the like, or a combination thereof) that provided by pump 130 as described above. In some aspects, a portion of pump 130 separate from that producing the pressurized water and fluid flow rate described above can be selectively engaged to generate second pressurized water at a second fluid flow rate. In another aspect, a second pump (not depicted) can be selectively engaged to generate the second pressurized water at the second fluid flow rate. In still other aspects, a separate water tank (not depicted, but see FIG. 5, infra) can be pressurized by pump 130 to generate the second pressurized water at the second fluid flow rate. An operator can switch from the pressurized water to the second pressurized water to change output capacity of pressure washer apparatus 100. Alternatively, or in addition, the operator can switch to combine the second pressurized water with the pressurized water to increase pressure, increase flow rate, or a combination of the foregoing, to change output capacity of pressure washer apparatus 100. Other variations not explicitly disclosed but understood in the art or reasonably conveyed to one of ordinary skill in the art by way of the context provided herein are also considered within the scope of the present disclosure.

Pressure washer apparatuses disclosed herein can include a selector mechanism to enable an operator to selectively engage the additional output capacity. In some embodiments, the selector mechanism can be mechanically coupled with trigger 126 of pressure washer apparatus 100. For instance, deploying trigger 126 a first displacement can cause release of fluid from pressurized output tip 124 as described above or conventionally known, whereas deploying trigger 126 a second displacement can cause engagement of the additional output capacity in conjunction with the release of fluid from the pressurized output tip 124. In other aspects, the selector mechanism can be separate from trigger 126 and can include a thumb-activated mechanism (e.g., switch, lever, button, dial, and so on), a remote-controlled mechanism (e.g., Bluetooth-activated switch coupled to a Bluetooth receiver device coupled to hand grip 128 that can activate the selector mechanism), a wired offhand selector mechanism (e.g., a pair of low voltage wires joined to pressure hose(s) 135, to hand grip 128, to trigger 126, or other selector mechanism), or the like, or a suitable combination of the foregoing.

FIG. 2 illustrates a block schematic diagram of an example pressure washer apparatus 200 with selective secondary output capacity according to alternative or additional aspects of the disclosed embodiments. Pressure washer apparatus 200 includes an electrical input power 202. Electrical input power 202 can be an alternative current (AC) electrical plug to connect with a 120V or 240V AC supply outlet, in some aspects. Alternatively, electrical input power 202 can include an AC generator, or other suitable electrical supply. In the example shown in FIG. 2, 120 VAC is provided from electrical input power 202 to a power converter 204. Power converter 204 can be an AC to direct current (DC) converter, that provides a suitable DC output voltage. In the example shown in FIG. 2, 60 VDc is provided, through others DC voltages (e.g., 12 volts, 18 volts, 24 volts, 48 volts, and so forth) can be output by power converter 204.

Pressure washer apparatus 200 can further comprise a DC motor 206 that receives electrical power from power converter 204 and outputs mechanical power via a mechanical linkage 208. When powered by DC motor 206, mechanical linkage 208 can drive a pump 210. A low pressure water inlet 220 supplies water at an input pressure to pump 210, which outputs high pressure water at high pressure water out 250. Pump 210 increases the pressure of water received from low pressure water in 220 to a first output pressure from the input pressure. In addition, pump 210 provides the high pressure water with a first flow rate.

In the embodiment shown by FIG. 2, a first portion of pump 212 is engaged by mechanical linkage 208 in response to operation of DC motor 206. The power received at electrical input power 202 can be selected to provide first portion of pump 212 sufficient mechanical power to generate first output water having a first increased pressure at a first flow rate. In an aspect of the disclosed embodiments, the first increased pressure (measured at an output tip, such as pressurized output tip 124 as shown in FIG. 1, supra) can be in a range from about 2,500 pounds per square inch (psi) to about 3,500 psi, or any suitable value or range therein (e.g., 2750 psi, 3000 psi, 3250 psi, and so forth). In a further aspect, the first flow rate can be about 0.75 gallons per minute (gpm) to about 1.25 gpm. In still additional aspects, the power received at electrical input power 202 can be about 120 VAC (e.g., 110V, 115V, 120V, 125V, etc.) and about 13 to about 16 amps (A) (e.g., 13.5 A, 14.5 A, 15 A, 15.8 A, and so on). The first output water provided to high pressure water out 250 can be a first output capacity for pressure washer apparatus 200.

Pump 210 can also include a second portion of pump 214. When deactivated, second portion of pump 214 can be isolated from low pressure water in 220, or can be isolated from mechanical linkage 208, or both. When deactivated then, second portion of pump 214 can generate no output water. When activated in response to an operator input (at an operator trigger mechanism, a switch, dial, lever, button, etc., a wireless connection, a wired connection, or the like—not depicted), a valve/battery switch connection 232 responsive to the operator input can open a valve 234 to couple low pressure water in 220 to second portion of pump 214. In addition, valve/battery switch connection 232 can connect a battery 230 to DC motor 206 to increase electrical power to DC motor 206. The increased electrical power can enable DC motor 206 to provide sufficient mechanical power via mechanical linkage 208 to generate second output water from second portion of pump 214 in combination with first output water from first portion of pump 212.

Second output water can be provided by second portion of pump 214 through a check valve 216 to high pressure water out 250. By adding second output water to the first output water, high pressure water out 250 can have an increased flow rate higher than the first flow rate of the first output water, an increased pressure higher than the first increased pressure, or a suitable combination of the foregoing. As one non-limiting example, the increased flow rate can be about 0.25 gpm to about 0.75 gpm above the first output water (e.g., about 1.0 gpm to about 2.0 gpm in total) at the first increased pressure (e.g., 2.5 kpsi to 3.5 kpsi). In various embodiments, battery 230 can be a 60 VDc battery. In alternative or additional embodiments, battery 230 can supply from 600 to 1800 watts DC to DC motor 206 to support (and maintain) mechanical power to first portion of pump 212 and second portion of pump 214. In combination with power converter 204, pressure washer apparatus 200 can supply about 2400 to about 3600 watts DC to DC motor 206 while valve/battery switch connection 232 is engaged.

FIG. 2A illustrates a pressure washer apparatus 200A with selective secondary output capacity according to alternative aspects of the present disclosure. Pressure washer apparatus 200A includes a dual pump system having a high pressure pump 212A and a high volume pump 214A. In the aspects depicted by FIG. 2A, DC motor 206 can be mechanically coupled by respective mechanical linkages 208A to high pressure pump 212A and to high volume pump 214A. In one example aspect of the disclosure, mechanical linkages 208A can operate to provide mechanical power to both high pressure pump 212A and high volume pump 214A simultaneously. In this example aspect, little to no power is consumed at high volume pump 214A when valve 234 is open and high volume pump 214A is isolated from low pressure water in 220. In this aspect, when valve/battery switch connection 232 is engaged, valve 234 opens to supply water to high volume pump 214A and battery 230 supplies additional power to DC motor 206 (or another motor-see below) to pressurize water at high pressure pump 212A and pressurize second water at high volume pump 214A.

In an alternative aspect, mechanical linkages 208A can operate to provide mechanical power separately to high pressure pump 212A and high volume pump 214A. For instance, high pressure pump 212A can engage DC motor 206 on demand (e.g., in response to an operator engaging trigger 126 as shown in FIG. 1), whereas high volume pump 214A can receive mechanical power only in response to activation of an operator input that closes valve/battery switch connection 232A (e.g., an operator trigger mechanism, a switch, dial, lever, button, etc., a wireless connection, a wired connection, or the like, or a suitable combination of the foregoing). In yet other aspects, DC motor 206 and mechanical linkage 208A can supply mechanical power to high pressure pump 212A alone, and a second motor and second mechanical linkage (not depicted) can selectively operate high volume pump 214A. For instance, in response to activation of the operator input and closing of valve/battery switch connection 232A, an optional pump activation 233A can activate (e.g., turn on) high volume pump 214A by closing valve 234 and connecting high volume pump 214A and a second motor to battery 230. This provides water to high volume pump 214A and allows the second motor to draw power from battery 230 and generate second mechanical output via the second mechanical linkage to power high volume pump 214A. In these latter aspects, battery 230 can be connected solely to the second motor, and not to DC motor 206 (as an alternative to the illustration shown in FIG. 2A and described at FIG. 2, supra).

High pressure pump 212A can be configured to generate first output water at a first increased pressure and a first flow rate in response to mechanical power output by DC motor 206 via mechanical linkage 208A. High volume pump 214A can be configured to generate second output water at a second flow rate, higher than the first flow rate, in response to mechanical power output by DC motor 206 via mechanical linkage 208A supplemented by battery 230 (or in response to mechanical power output by a second motor and second mechanical linkage—not depicted-powered by battery 230). In combination, the first water output and the second water output provided to high pressure water out 250 can achieve water at approximately the first increased pressure (or above) and at the second flow rate. The first increased pressure can be in a range from about 2.5 kpsi to about 3.5 kpsi or any suitable value or range there between; the first flow rate can be in a second range from about 0.75 gpm to about 1.25 gpm, and the second flow rate can be in a third range from about 1.25 gpm to about 2.0 gpm, in various aspects of the disclosed embodiments. Different combinations increased pressure values or sub-ranges in combination with flow rate values or sub-ranges can be achieved among the various aspects as well.

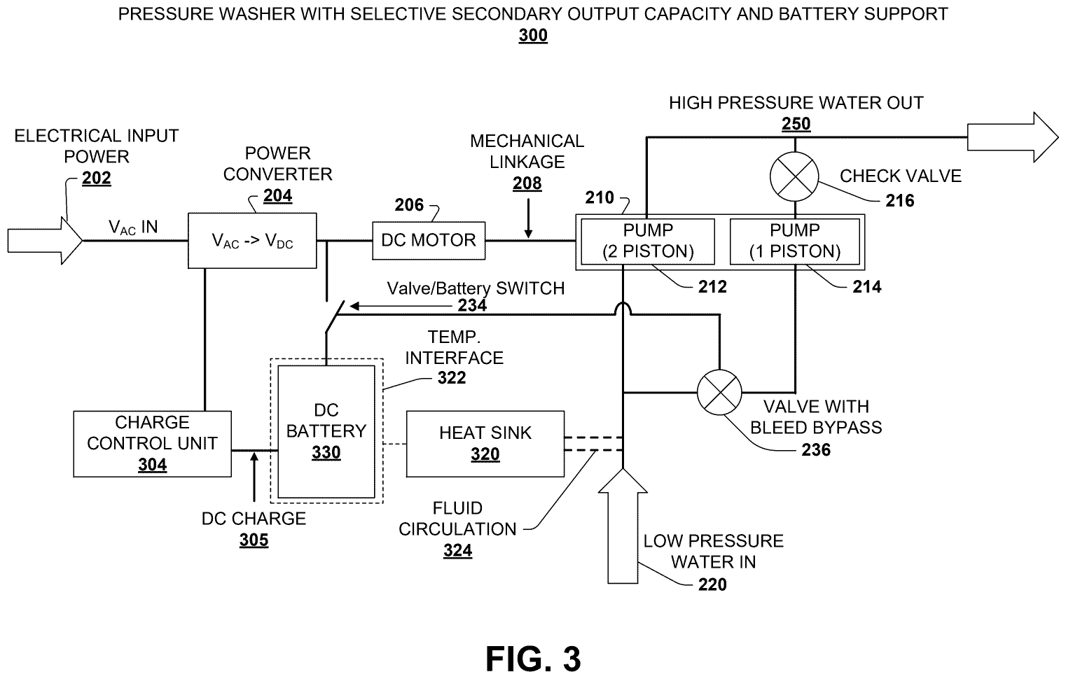

FIG. 3 illustrates a block schematic diagram of an example pressure washer apparatus 300 with selective secondary output capacity and battery support, in one or more additional aspects of the disclosed embodiments. Pressure washer apparatus 300 can include electrical input power 202 and a power converter 204 to supply DC power to a DC motor 206. An output of DC motor 206 is a mechanical linkage providing mechanical power from DC motor 206 to a pump 210. In the aspects of the disclosure shown in FIG. 3, pump 210 can be a multi-drive pump. For instance, pump 210 can be a multi-drive positive displacement pump. In at least one aspect, the multi-drive pump can be a multi-piston positive displacement pump. A first portion of pump 212 can be continually coupled to low pressure water 220, having consistent access to water at a pressure supplied by low pressure water in 220. A second portion of pump 214 can be conditionally coupled to low pressure water 220 by a valve 236. Valve 236 is generally deactivated to isolate second portion of pump 214 from low pressure water in. When activated, valve 236 can open and supply water from low pressure water in 220 to second portion of pump 214.

A battery 330 is provided to supplement electrical power at DC motor 206 (or a second electric motor—not depicted, but see FIG. 2A, supra) to support providing mechanical power to second portion of pump 214. Battery 330 can be a rechargeable battery sufficient to store a number of amp-hours of electrical power. In addition, a charge control unit 304 can couple a de charging input 305 of battery 330 with power converter 204. Charge control unit 304 can therefore facilitate charging of battery 330 while pressure washer apparatus 300 is in use and receiving electrical power at electrical input power 202. In some aspects of the disclosed embodiments, pressure washer apparatus 300 can include a heat sink 320 and temperature interface 322 to maintain a target temperature or target range of temperatures for battery 330. The target temperature or range of temperatures can be selected to maximize charging rate of battery 330 to maximize efficiency of recharging battery 330 at dc charging input 305. Temperature interface 322 can be a thermally conductive material configured to provide thermal contact between battery 330 and heat sink 320. Optionally, a fluid circulation 324 can be supplied through heat sink 320 to temperature interface 322 to supply a flow of fluid at a preferred temperature to facilitate cooling battery 330 (e.g., room temperature, lower temperature than battery 330 in operation, a temperature equal or lower than the target temperature of battery 330, and so forth). Fluid utilized for fluid circulation 324 can be water from low pressure water in 220 in some aspects of the disclosed embodiments. In other aspects, the fluid can be air, or another fluid (e.g., thermal gel, etc.) stored in a fluid storage (not depicted) and circulated through heat sink 320 to temperature interface 322.

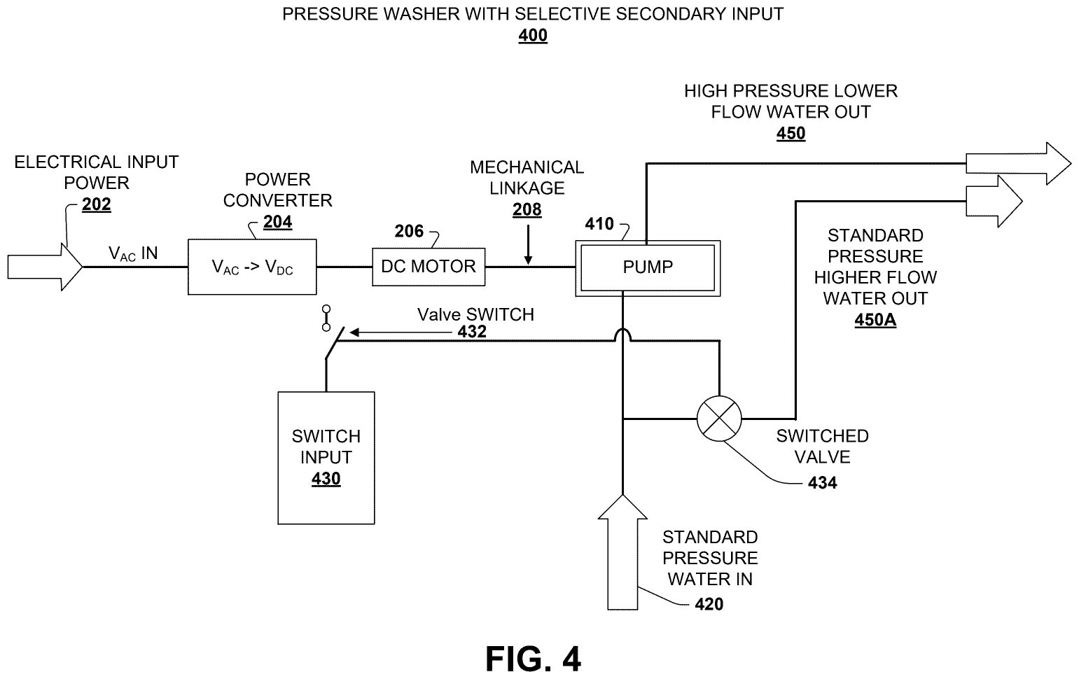

FIG. 4 depicts a block schematic diagram of an example pressure washer apparatus 400 according to alternative or additional aspects of the disclosed embodiments. Example pressure washer apparatus 400 includes an electrical input power 202, a power converter 204 and DC motor 206 for providing mechanical power at a mechanical linkage 208 from the electrical input power 202. The mechanical power is provided to a pump 410 that receives water from a standard pressure water inlet 420 and outputs high pressure water at a high pressure lower flow water out 450.

In addition, pressure washer apparatus 400 can comprise a switch input 430 that opens and closes a switched valve 434 by way of a valve switch connection 232. Switched valve 434 connects standard pressure water in 420 to a standard pressure higher flow water out 450A. The standard pressure high flow water out 450A can have a substantially larger flow rate than high pressure lower flow water out 450, such as about 3.0 gpm to about 5.0 gpm and a water pressure matching that of a standard residential, commercial or industrial building or infrastructure (e.g., about 45 psi to about 80 psi). In contrast, high pressure lower flow water out 450 can have much lower flow rate than the standard building or infrastructure flow rate (e.g., about 1.5 gpm or less) but at much higher pressure (e.g., about 2.5 kpsi to about 3.5 kpsi). Pressure washer apparatus 400 can provide dual capacity output, that provides a high pressure output coupled with a standard pressure bypass. The high pressure output can be effective in delivering high energy fluid to a target, whereas the higher flow output can be effective in rinsing the target with the larger volume and flow of fluid.

FIG. 5 depicts a block schematic diagram of an example pressure washer apparatus 500 according to still further aspects of the disclosed embodiments. Example pressure washer apparatus 500 includes an electrical input power 202, a power converter 204 and DC motor 206 for providing mechanical power via a mechanical linkage 208 from the electrical input power 202. The mechanical power is provided to a pump 510 that receives water from a standard pressure water inlet 220. Pump 510 receives the water and mechanical power and generates first output water at a first increased pressure and a first flow rate. The first output water is dispensed from power washer apparatus 500 at a high pressure water out 550.

In addition, pressure washer apparatus 500 can comprise an accumulation tank 534 that can store water received from low pressure water in 220 by way of a valve 234. A trigger switch 530 can be configured to redirect mechanical pressure to accumulation tank 534 to pressurize the water contained in accumulation tank 534. Once pressurized, the water within accumulation tank 534 can be utilized as a selective secondary output capacity by way of auxiliary pressure water out 550A and check valve 216. For instance, in response to activation of an operator switch, trigger, button, etc., check valve 216 can be opened to selectively dispense pressurized water by way of auxiliary pressure water out 550A to join high pressure water out 550, and increase a flow rate of high pressure water out 550, increase a pressure of high pressure water out 550, or increase a flow rate and pressure of high pressure water out 550, in various aspects of the disclosed embodiments.

In an aspect, trigger switch 530 can monitor a trigger of pressure washer apparatus (e.g., operator trigger 126 of FIG. 1, supra). When deactivated, trigger switch 530 can open switched valve 536 to supply pressurized output from pump 510 to accumulation tank 536. Valve 234 can be opened by trigger switch 530 in response to deactivation of the trigger, or can be opened until a volume meter (not depicted) within accumulation tank 534 is activated at a predetermined fill volume, which can shut off valve 234. Alternatively, a pressure meter associated with an optional regulator shut-off 538 can open valve 234 in response to pressure within accumulation tank 534 dropping below a predetermined pressure value (e.g., below a pressure of low pressure water in 220). Similarly, optional regulator shut-off 538 can be selected to close switched valve 536 in response to pressure within accumulation tank 534 exceeding a maximum pressure.

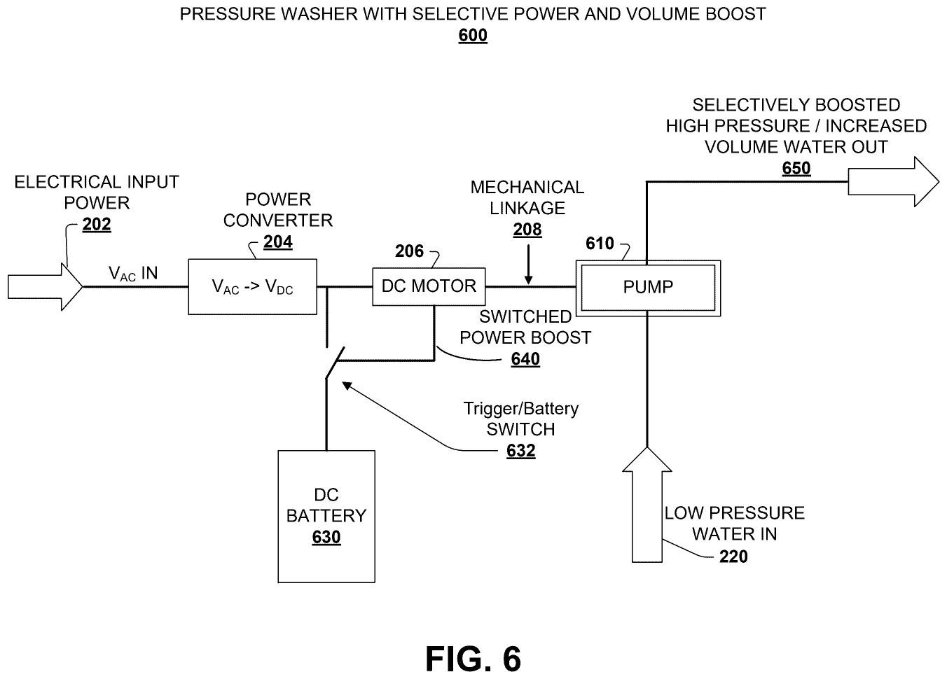

FIG. 6 depicts a schematic block diagram of an example pressure washer apparatus 600 according to still further aspects of the disclosed embodiments. Example pressure washer apparatus 600 includes an electrical input power 202, a power converter 204 and DC motor 206 for providing mechanical power via a mechanical linkage 208 from the electrical input power 202. The mechanical power is provided to a pump 610 that receives water from a low pressure water inlet 220. Pump 610 receives the water and mechanical power and generates first output water at a first increased pressure (compared to low pressure water in 220) and a first flow rate. The first output water is dispensed from pressure washer apparatus 600 at a selectively boosted high pressure/increased volume water out 650.

In addition, pressure washer apparatus 600 can comprise a battery 630 suitable to selectively provide increased electrical power as an input to DC motor 206. A switched power boost 640 can couple a power output of battery 630 to a power input of DC motor 206. Switched power boost 640 can close the power output in response to activation of an operator input, such as a power boost switch (or, e.g., an operator trigger mechanism, a switch, lever, button, dial, etc., wireless connection, wired connection, or the like, or a suitable combination of the foregoing). The increased electrical power can cause DC motor 206 to generate an increased mechanical power output by way of mechanical linkage 208 to pump 610. Pump 610 can be configured to generate second output water at a second increased pressure, higher than the first increased pressure, in response to the increased mechanical power. Alternatively, or in addition, pump 610 can be configured to generate a second flow rate higher than the first flow rate in response to the increased mechanical power. In still further aspects, pump 610 can be configured to generate a third increased pressure (higher than the first increased pressure) and a third flow rate (higher than the first flow rate) in response to the increased mechanical power. In some aspects, operation of pump 610 can be controlled by an operator control (e.g., dial, switch, etc.) to select an increased flow rate and increased pressure for selectively boosted high pressure/increased volume water out 650 in response to switched power boost 640 providing power output of battery 630 to power input of DC motor 206.

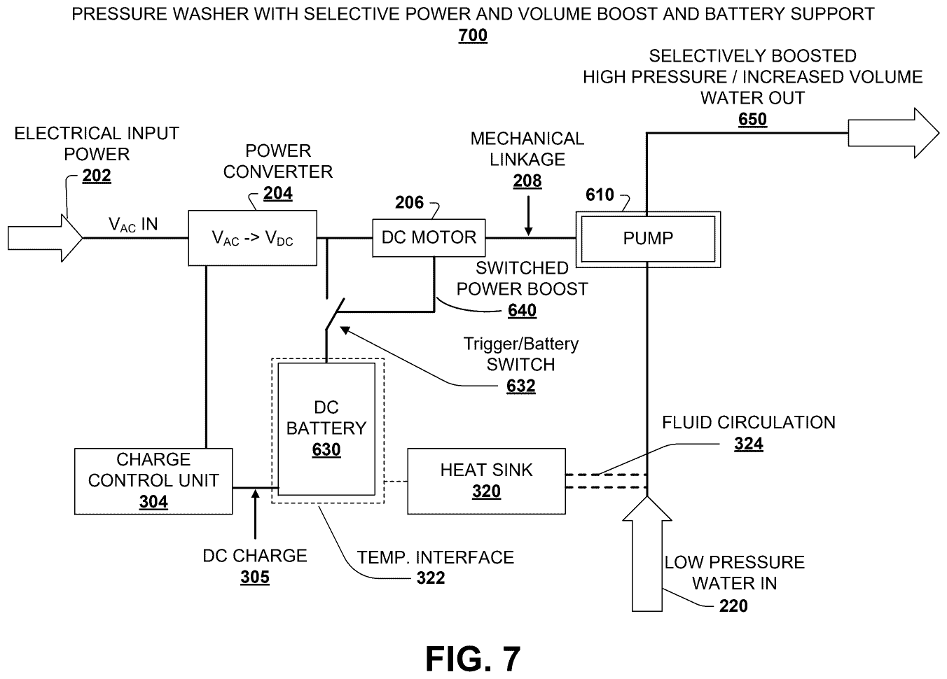

FIG. 7 depicts a schematic block diagram of an example pressure washer apparatus 700 according to still further aspects of the disclosed embodiments. Example pressure washer apparatus 700 includes an electrical input power 202, a power converter 204 and DC motor 206 for providing mechanical power via a mechanical linkage 208 to a pump 610. In addition, pressure washer apparatus 700 can comprise a battery 630 suitable to selectively provide increased electrical power as an input to DC motor 206. A switched power boost 640 can couple a power output of battery 630 to the input of DC motor 206 in response to an operator input (e.g., an operator trigger mechanism, a switch, lever, button, dial, etc., wireless connection, wired connection, or the like, or a suitable combination of the foregoing).

Battery 630 can be a rechargeable battery sufficient to store a number of amp-hours of electrical power. In addition, a charge control unit 304 can couple a de charging input 305 of battery 630 with power converter 204. Charge control unit 304 can therefore facilitate charging of battery 330 while pressure washer apparatus 300 is in use and receiving electrical power at electrical input power 202. In some aspects of the disclosed embodiments, pressure washer apparatus 700 can include a heat sink 320 and temperature interface 322 to maintain a target temperature or target range of temperatures for battery 630. The target temperature or range of temperatures can be selected to maximize charging rate of battery 630 to maximize efficiency of recharging battery 630 at de charging input 305. Temperature interface 322 can be a thermally conductive material configured to provide thermal contact between battery 630 and heat sink 320. Optionally, a fluid circulation 324 can be supplied through heat sink 320 to temperature interface 322 to supply a flow of fluid at a preferred temperature to facilitate cooling battery 630 (e.g., room temperature, lower temperature than battery 630 in operation, a temperature equal or lower than the target temperature of battery 630, and so forth). The fluid can be water (e.g., from low pressure water in 220), air, or another fluid (e.g., thermal gel, etc.) stored in a fluid storage (not depicted) and circulated through heat sink 320 to temperature interface 322.

Generally, the illustrated embodiments are not provided as strict limitations on how the disclosed aspects can be practiced by one of ordinary skill in the art but are intended to be provided as examples that can be modified, interchanged, added to or subtracted from as would be suitable to one of ordinary skill in the art to accomplish the purposes and objectives described herein. As an example, an arrangement of components depicted in one Figure(s) can be swapped with components depicted in another Figure(s), optionally excluding some components or including other components illustrated in a third Figure(s), according to design creativity of one of ordinary skill in the art. For instance, accumulation tank 534, valve 234, switched valve 536, trigger switch 530 and auxiliary trigger/pump switch 532 of FIG. 5 can be arranged together with power washer apparatus 100 of FIG. 1, and optionally DC battery 630, trigger/battery switch 632 and switched power boost 640 of FIG. 6, and charge control unit 304, heat sink 320, fluid circulation 324 and temperature interface 322 of FIG. 3, as suitable. As a further example, components of disclosed devices can be implemented as connected to other components rather than included within the parent device. For instance, first portion of pump 212 and second portion of pump 214 can be implemented as separate pumps rather than components of pump 210. Alternatively, the opposite orientation can be implemented within the scope of the disclosure: one component (e.g., power converter 204) depicted separate from another component (e.g., charge control unit 304) can be aggregated as a single component in some embodiments. Additionally, it is noted that one or more disclosed processes can be combined into a single process providing aggregate functionality. Still further, components of disclosed machines/devices/sensors/switches can also interact with one or more other components not specifically described herein but known by those of skill in the art.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as electronic hardware configured to implement the functions, or a computer-readable medium having computer-executable instructions for performing the acts or events of the various processes.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. The block diagrams of the architecture and flow charts are grouped for ease of understanding. However, it should be understood that combinations of blocks, additions of new blocks, re-arrangement of blocks, and the like are contemplated in alternative embodiments of the present disclosure.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A pressure washer apparatus, comprising:
a frame;
an electric motor secured to the frame for generating mechanical power;
a water inlet for receiving water;
a pump secured to the frame that receives water from the water inlet and mechanical power from the electric motor and generates pressurized water having a first increased pressure and a first fluid flow rate;
a sprayer device for directing output water having the first increased pressure and the first fluid flow rate;
an operator trigger for selectively releasing the output water at the sprayer device; and
an auxiliary output modality which, in response to activation of an operator input, increases the first increased pressure of the output water to a second increased pressure or increases the first fluid flow rate of the output water to a second fluid flow rate.

2. The pressure washer apparatus of claim 1, wherein:
the auxiliary output modality comprises a rechargeable battery that provides supplemental electric power to the electric motor in response to the activation of the operator input, the supplemental electric power increasing a total power input at the electric motor; and
the electric motor increases the mechanical power in response to the increased total power input and causes the pump to increase the first increased pressure of the output water to the second increased pressure, or to increase the first fluid flow rate to the second fluid flow rate.

3. The pressure washer apparatus of claim 2, wherein the pump is a three-piston positive displacement pump and further wherein:
a first piston and a second piston of the pump operate to produce the output water having the first increased pressure and the first fluid flow rate; and
in response to the activation of the operator input, a third piston of the pump is engaged and together with the first piston and the second piston and the increased mechanical power output by the electric motor, causes the pump to produce the output water having the second increased pressure or the second increased fluid flow rate.

4. The pressure washer apparatus of claim 3, further comprising a valve that separates the water inlet from a pump chamber operated upon by the third piston, wherein:
absent activation of the operator input the valve is closed and prevents water from the water inlet from supplying the pump chamber; and
in response to activation of the operator input the valve opens and supplies water to the pump chamber to facilitate engaging the third piston of the pump.

5. The pressure washer apparatus of claim 2, wherein:
absent activation of the operator input, the water inlet supplies water to a first pump chamber and a second pump chamber of the pump, enabling the pump to produce the first increased pressure and the first fluid flow rate;
in response to activation of the operator input the water inlet selectively supplies the water to a third pump chamber; and
the increased mechanical power enables the pump to substantially maintain the first increased pressure while increasing the first fluid flow rate about fifty percent to the second fluid flow rate.

6. The pressure washer apparatus of claim 1, wherein the auxiliary output modality comprises:
a rechargeable battery that provides supplemental electric power in response to activation of the operator input;
a second electric motor powered by the supplemental electric power generating supplemental mechanical power;
a second pump secured to the frame that receives water from the water inlet and the supplemental mechanical power from the second electric motor to produce second output water; and
a check valve that outputs the second output water and the output water at the sprayer device to produce combined output water, wherein the combined output water has the second increased pressure or has the second fluid flow rate.

7. The pressure washer apparatus of claim 1, wherein the auxiliary output modality comprises:
a pressure tank coupled to the water inlet and coupled to the pump;
a valve that selectively supplies water from the water inlet to the auxiliary pressure tank;
a trigger switch that couples the mechanical power output from the pump to the pressure tank to pressurize water contained within the auxiliary pressure tank; and
an output valve that, in response to activation of the operator input, couples an output of the pressure tank to the sprayer device to join the auxiliary output water with the water output.

8. The pressure washer apparatus of claim 7, wherein the auxiliary output water increases the output water at the sprayer device to the second fluid flow rate.

9. The pressure washer apparatus of claim 7, wherein the trigger switch:
couples the pump to the pressure tank in response to deactivation of the operator trigger; and
recouples the pump to the water inlet to generate the pressurized water in response to reactivation of the operator trigger.

10. The pressure washer apparatus of claim 9, further comprising a regulator shut-off that measures a pressure of the pressure tank and deactivates the pump in response to the pressure of the pressure tank reaching a predetermined pressure while the operator trigger is deactivated.

11. A pressure washer apparatus, comprising:
an alternating current (AC) power input;
an AC to direct current (DC) converter that converts AC power received at the AC power input to DC power;
a DC electric motor that receives the DC power and outputs mechanical power;
a water inlet that receives water at an input pressure;
a pump that receives water from the water inlet and receives the mechanical power from the DC electric motor, and increases pressure of the water from the input pressure to a first increased pressure;
a pressurized water output for selective release of output water at the first increased pressure and a first fluid flow rate;
an operator trigger for activating and deactivating the release of the output water at the pressurized water output; and
an auxiliary water output selectively activatable to generate second pressurized water and increase the first fluid flow rate of the output water at the pressurized water output to a second fluid flow rate, larger than the first fluid flow rate.

12. The pressure washer apparatus of claim 11, wherein the second fluid flow rate is about 50 percent greater than the first fluid flow rate.

13. The pressure washer apparatus of claim 11, wherein the pump is a multi-drive pump having at least one drive activated by the mechanical power to increase pressure of the water from the input pressure to the first increased pressure, and at least one additional drive that is independent of the water pressurized by the at least one drive, wherein the auxiliary water output further comprises:
a second power source independent of the AC to DC converter;
the at least one additional drive of the multi-drive pump;
an auxiliary water output actuator selectively activatable by an operator; and
an auxiliary inlet coupled to the water inlet and a water valve that selectively isolates the water inlet from the at least one additional drive of the multi-drive pump, wherein in response to activation of the auxiliary water output actuator the water valve supplies second water from the water inlet to the at least one additional drive, which produces the second pressurized water from the second water.

14. The pressure washer apparatus of claim 13, wherein the second power source is a rechargeable battery that supplies additional DC power to the DC electric motor to power the pressurizing of the second water by the at least one additional drive in addition to powering the pressurizing of the water by the at least one drive.

15. The pressure washer apparatus of claim 13, wherein:
the multi-drive pump is a three-piston positive displacement pump;
the at least one drive that increases pressure of the water to the first increased pressure includes two pistons of the three-piston positive displacement pump;
the at least one additional drive that produces the second pressurized water from the second water is a third piston of the three-piston positive displacement pump.

16. The pressure washer apparatus of claim 11, wherein the auxiliary water output further comprises:
a second power source;
a second pump having an output coupled to the pressurized water output and an input coupled to the water inlet by way of a valve;
an auxiliary water output actuator that opens and closes the valve to connect or isolate second water from the water inlet with the second pump, respectively, and that activates and deactivates the second power source to facilitate operation of the second pump to generate the second pressurized water from the second water at the output.

17. The pressure washer apparatus of claim 16, wherein at least one of:
the second pump receives the mechanical power from the DC electric motor and the second power source supplements DC current at the DC electric motor to produce the mechanical power to support both the pump and the second pump; or
the pressure washer apparatus comprises a second electric motor coupled to the second power source that generates second mechanical power output to the second pump.

18. The pressure washer apparatus of claim 11, wherein the auxiliary water output further comprises:
a water tank coupled to the water inlet by a selectively activatable valve, coupled to the pump by a pressure valve, and having an output selectively coupled to the pressurized water output; and
a trigger switch coupled to the operator trigger and responsive to deactivation of the operator trigger to open the pressure valve and couple the water tank to the pump and generate the second pressurized water from water contained within the water tank.

19. The pressure washer apparatus of claim 18, wherein the trigger switch opens the selectively activatable valve in response to deactivation of the operator trigger to supply water from the water inlet to the water tank.

20. The pressure washer apparatus of claim 18, further comprising an auxiliary water activation input that couples the output of the water tank to the pressurized water output to combine the second pressurized water with the output water at the first increased pressure to increase the first fluid flow rate to the second fluid flow rate at the pressurized water output.
